(19) United States
(12) Patent Application Publication
(10) Pub. No.: US 2026/0055925 A1
(43) Pub. Date: Feb. 26, 2026

(54) HEATING DEVICE AND ELECTRICAL DEVICE WITH SUCH A HEATING DEVICE

(71) Applicant: E.G.O. Elektro-Gerätebau GmbH, Oberderdingen (DE)

(72) Inventors: Holger Köbrich, Kraichtal-Gochsheim (DE); Manuel Schmieder, Oberderdingen (DE); Hannes Kümmerle, Bretten (DE)

(21) Appl. No.: 19/262,223

(22) Filed: Jul. 8, 2025

(30) Foreign Application Priority Data
Aug. 20, 2024 (DE) 10 2024 123 764.3

(51) Int. Cl. F24H 1/00; H05B 1/02; H05B 3/26

(52) U.S. Cl. CPC F24H 1/0072; F24H 1/0018; H05B 1/0205; H05B 3/262; F24H 2250/02; H05B 2203/003

(57) ABSTRACT

A heating device has a carrier and an electrically insulating basic insulation layer thereon and at least one heating conductor circuit thereon, wherein the at least one heating conductor circuit has at least one heating conductor and electrical connections thereon. Underneath the basic insulation layer and between the latter and the carrier, an electrically insulating additional insulation layer is arranged on the carrier, wherein an electrically conductive layer is arranged distributed over its surface such that the basic insulation layer is arranged directly on the conductive layer. A PE connection is provided on the carrier or on the additional insulation layer and is connected to ground, wherein a safety fuse between the conductive layer and the carrier or PE connection is arranged as the only electrical connection between the conductive layer and the carrier or ground connection.

### CROSS-REFERENCE TO RELATED APPLICATIONS

This application claims priority to Germany Application No. 10 2024 123 764.3, filed Aug. 20, 2024, the contents of which are hereby incorporated herein in its entirety by reference.

### AREA OF APPLICATION AND PRIOR ART

The invention relates to a heating device with a carrier and with at least one heating conductor circuit thereon which has at least one heating conductor. Furthermore, the invention relates to an electrical device with such a heating device, in particular to a water-carrying household appliance such as a washing machine or a dishwasher, for example.

Heating devices that can be used for example for washing machines having so-called thick-film heating elements are known from US 2022/386420 A1 or U.S. Pat. No. 7,941,884 A1. A basic insulation layer, on or above which a heating conductor circuit with several heating conductors is applied in turn, can be applied to a carrier, in particular if the latter consists of metal. In operation, the problem may arise that the basic insulation layer might be damaged in the event of overheating of the thick-film heating element. If the carrier then consists of metal, a short-circuit towards the thick-film heating element or an electrical connection thereof can occur, with a corresponding risk to an operator.

### OBJECT AND SOLUTION

The object underlying the invention is to provide a heating device as mentioned at the outset and an electrical device provided therewith, with which devices problems of the prior art can be solved and it is particular possible to increase the safety of the heating device and the electrical device during operation and to eliminate sources of electrical hazards.

This object is achieved by a heating device having the features of claim 1 and by an electrical device having the features of claim 25. Advantageous and preferred embodiments of the invention are the subject matter of the further claims and are explained in greater detail below. Some of the features are only described for the heating device or only for the electrical device. They are however intended to apply, by themselves and independently of one another, both for such a heating device and for such an electrical device. The wording of the claims is incorporated into the content of the description by express reference.

The heating device has a carrier and an electrically insulating basic insulation layer on this carrier. Advantageously, this basic insulation layer is applied directly onto the carrier. The carrier may for example consist of metal, but this is not essential. This is explained in more detail below. At least one heating conductor circuit having electrical connections is arranged on or above the basic insulation layer. Advantageously, these electrical connections are designed as plug connections, for example with plug connection lugs or plug connection sockets fastened directly on the heating device. The at least one heating conductor circuit has at least one heating conductor, advantageously several, wherein a variety of configurations are possible here, as are also substantially known from the prior art. This is explained in more detail below.

It is provided in accordance with the invention that underneath the basic insulation layer, which serves mainly to electrically insulate the heating conductor circuit or the heating conductor circuits directly from the carrier, an electrically insulating additional insulation layer is provided. This layer is therefore located between the basic insulation layer and the carrier, advantageously directly applied onto a carrier upper side, possibly after prior surface treatment of the latter. There is therefore a two-layer structure for the electrical insulation between the carrier and the at least one heating conductor circuit. Advantageously, the layer structure, made up of the additional insulation layer on the carrier and the basic insulation layer above it, is identical for all heating conductor circuits. Furthermore, an electrically conductive layer is provided on the additional insulation layer, arranged distributed over its surface, preferably as a closed surface, alternatively as a grid or net. The basic insulation layer extends in turn on this conductive layer such that the latter layer extends between the additional insulation layer and the basic insulation layer. There is therefore substantially an at least three-layer structure on the carrier, namely the additional insulation layer, the conductive layer and above it the basic insulation layer. The conductive layer is designed such that a current that flows from the heating conductor circuit through a basic insulation layer, damaged due to a fault, flows into the conductive layer. The conductive layer is at least reachable from the outside or routed outwards, such that a ground connection is provided on it, preferably directly on it, or at it. Preferably, the connection to ground or PE is not provided directly on it, but is connected to it in electrically conducting manner. The ground connection is connected to ground or PE. Such a connection to ground or PE is usually present in electrical devices if the latter are connected to a mains system in a household. This is very sensible and also mandatory. The function of a standard PE connection of this type is of course known to the person skilled in the art. The conductivity of the conductive layer should be such that in normal operation, or when the current flowing through the heating conductor circuit is flowing through the conductive layer too, the latter does not noticeably heat up. Its electrical resistance can also be between 5 times and 100 times lower than that of the heating conductor, preferably lower than 0.1 Ohm mm²/m.

Finally, the heating device also has a safety fuse, which is provided between the conductive layer and the carrier or between the conductive layer and the ground connection, and is also the only electrical connection between the conductive layer and the ground connection. Advantageously, this safety fuse is not replaceable, but permanently arranged or permanently connected to the heating device, particularly advantageously as an integral and undetachable component of the heating device.

It can be achieved by this structure of the heating device that in the event that the basic insulation layer is damaged or is not effecting full electrical insulation of the heating conductors arranged thereon, and in effect an electrical connection of the at least one heating conductor to the conductive layer is enabled by the basic insulation layer, current can flow for a short time from the heating conductor into the conductive layer through the basic insulation layer. A fault of this type may occur if the heating device runs dry or if the heat generated cannot be dissipated, leading to temperatures from 500° C. to 700° C. This current through the basic insulation layer then flows from the conductive layer via the electrical connection to the carrier or to the ground connection or PE connection, wherein in particular it may be the only electrical connection of this type. The current flows here inevitably through the safety fuse, which is dimensioned such that it is then destroyed, performing the original function of a safety fuse. To do so, it can be designed for example to be destroyed at a current of over 100 mA, wherein it can however also conduct a high current for a very short time. The safety fuse can be designed as a fast-blow fuse, in accordance with the usual designation, such that it reacts or is destroyed within less than 100 msec or within less than 5 msec at the stated current strength. When the safety fuse blows, the heating conductor is as a rule already destroyed.

It is thus achieved with the invention that safety is assured in the event of an excessive temperature as stated above due to operation of the heating conductor or heating conductor circuit, which can burn out with the result that the basic insulation layer is damaged or destroyed and loses its electrically insulating properties. If a current then flows through it from the heating conductor circuit or from one of the heating conductors, it flows into the electrically conductive layer underneath due to the damage in the basic insulation layer, i.e. it can flow off, and not also flow to the carrier through the additional insulation layer, possibly damaging the latter too. From there, the current flows via the safety fuse to the PE connection. The resultant current flow then destroys the safety fuse above a certain level or depending on how the fuse is dimensioned. Due to provision of the additional insulation layer directly on the carrier or between the carrier and the basic insulation layer, the carrier is in any event still electrically insulated such that no risk can arise for an operator. The destruction or penetration of the top electrical insulation layer, i.e. of the basic insulation layer, thus effects the triggering or destruction of the safety fuse, which can in effect still divert the current to the PE connection for a short time before it is destroyed itself. This may in turn be recognized by an evaluation of the heating device or in a control unit or power supply for the heating device, for example because current is no longer flowing through the destroyed heating conductor circuit, no temperature rise is being registered using separate temperature sensors, or the destruction of the safety fuse has been registered.

In a development of the invention, it is possible for each of the said layers, i.e. basic insulation layer, additional insulation layer and conductive layer, to consist of several sequentially applied layers. They each however act like a single layer.

In an advantageous embodiment of the invention, the carrier is electrically conductive, for example consisting of metal or of a so-called thick-film steel. The stated PE connection is then arranged on the carrier, in particular arranged directly thereon, and preferably permanently welded thereto. The safety fuse can reach or extend from the conductive layer directly onto the carrier, wherein it is connected both to the latter and to the PE connection, advantageously as a plug connection.

In a further embodiment of the invention, an electrically conductive contact field, which is connected to the carrier in electrically conducting manner, may be applied, for example soldered or welded, to the carrier next to the stated additional insulation layer. The safety fuse can then reach from the conductive layer directly onto this contact field and be electrically connected thereto. To do so, the carrier is advantageously designed to be electrically conductive and has the ground connection, or the latter is arranged or fastened the carrier. It may be advantageously provided here that the stated contact field is at the level of the conductive layer or that an upper side of the contact field is at approximately the same level as an upper side of the conductive layer. The safety fuse can then extend from the conductive layer to the contact field, in effect parallel to the carrier. It can for example be securely positioned and fastened, in a manufacturing process, by means of soldering, in particular by means of SMD soldering. The contact field can here be at a lateral distance from the additional insulation layer and advantageously also from the conductive layer, so that no short-circuit arises that might continue to exist after destruction of the safety fuse. The contact field can also overlap at least partially onto the additional insulation layer.

In an alternative embodiment of the invention, an additional contact field, which in turn is connected in electrically conductive manner to the ground connection or PE connection, can be applied to the additional insulation layer itself. The safety fuse is then connected to this additional contact field in electrically conductive manner. Whereas in the previously described first case the electrical contact is therefore made with the carrier and with a ground connection or PE connection provided thereon, in the second case as described here an electrical connection via the safety fuse is only made at the ground connection. A further ground connection or PE connection is thus needed, since the carrier should have its own such ground connection, in particular when the heating device is provided for the heating of water.

In one embodiment of the invention, the safety fuse may be designed in metal or as a metal part, advantageously as an exposed or freely extending metal part. The safety fuse is designed preferably as an SMD component such that it can be fastened to the heating device by means of SMD soldering and provided with electrical contacts. This permits automated fastening and contacting.

In a development of the invention, the safety fuse may be designed as a so-called fast-blow fuse. It may be designed for a reaction time of less than 50 msec, advantageously less than 5 msec, such that it blows after no later than 50 msec or 5 msec when a specific current strength or a higher current strength flows through it. Generally speaking, this blowing of the safety fuse can be recognized by a control unit which controls the heating device or effects its power supply. A test circuit can be formed through which a test current flows, i.e. through the safety fuse too, for example by making electrical contact to the conductive layer on one hand and to the ground connection on the other. If this fuse is destroyed, the test circuit is interrupted, which can be regarded as an indication of the destruction and hence failure of the basic insulation layer and also of the entire heating device. As a rule, this heating device is then permanently unusable and destroyed, which however is caused in any case by penetration or destruction of the basic insulation layer, which must then be replaced.

An aforementioned current strength at which the safety fuse is destroyed or blows, in particular within the aforementioned time, can be a maximum of 0.5 A. Advantageously, it is lower, for example a maximum of 0.1 A. As a result, even relatively minor damage to the basic insulation layer, and relatively low current flows through the latter and via the conductive layer to the safety fuse, are sufficient to trigger or destroy the latter. Nevertheless, the safety fuse can also conduct considerably higher currents for a very short time.

The safety fuse should advantageously be designed such that when it blows or is destroyed, the additional insulation layer is not damaged, so that the latter can in any event continue to electrically insulate the heating conductor against the carrier. The conductive layer, together with the safety fuse, thus serves to protect and maintain this electrical insulation of the carrier in any event. This serves to increase safety in the heating device and in the electrical device provided therewith during operation.

In a development of the invention, the conductive layer and the basic insulation layer may extend over a surface such that the heating conductors of the at least one heating conductor circuit, in particular of a single heating conductor circuit, extend inside or above it. Furthermore, the basic insulation layer should extend within a surface of the conductive layer such that when any penetration of the basic insulation layer occurs, part of the conductive layer in effect becomes free or is exposed. In a development of the invention, it may be provided that the conductive layer extends correspondingly to the at least one heating conductor or to all heating conductors of a heating conductor circuit. It may be provided here, in the case of several heating conductor circuits, that each of them has its own conductive layer. These conductive layers may then be advantageously separate from one another. Alternatively, a conductive layer connected in a continuously electrically conductive manner or a common conductive layer may be provided. However, even with a corresponding extent of this type the conductive layer should extend correspondingly to the heating conductors, but project beyond them in their width.

In a possible embodiment of the invention, the conductive layer may be designed over a surface, possibly covering at least 70% to 90% of the carrier or of the additional insulation layer. It can form a closed surface. Alternatively, the conductive layer may also be designed as a net or grid, wherein a total surface area of the net conductors or grid conductors is smaller than a non-covered total surface area of the additional insulation layer. Alternatively, the conductive layer may also extend in meandering form and in strips, wherein this preferably also applies for the heating conductors above, allowing the shape of the conductive layer to be advantageously adjusted to the shape of the heating conductors. These strips may have a width of a maximum of 3 mm, wherein the heating conductors should have a width of a maximum of 2.5 mm or a maximum of 2 mm. Preferably, the width of the strips of a meandering conductive layer should have the maximum width of the heating conductors or exceed it by 5% to 50%. In this case, the conductive layer may extend between all heating conductors and the carrier or additional insulation layer.

In a development of the invention, the heating device may have several heating conductor circuits operable separately from one another, wherein each of these heating conductor circuits has at least one heating conductor, advantageously several heating conductors. A separate conductive layer extending over a corresponding surface may then be provided for each of these heating conductor circuits, wherein each of these heating conductor circuits extends on and inside the limits of this conductive layer.

It may be provided that the safety fuse and the entire heating device are designed such that a common basic insulation layer is provided for all conductive layers underneath all the heating conductor circuits. A separate safety fuse having an electrically conducting connection to a ground connection may be provided for each heating conductor circuit and for each associated conductive layer. This allows detection of which of the several safety fuses has blown due to a damaged basic insulation layer underneath a particular heating conductor. This heating conductor circuit can then be switched off by the control unit as described above. Further operation can then be continued with the other heating conductor circuits, possibly in emergency operation, which is however still better than when no operation at all is possible. It would be possible to provide three or four separate heating conductor circuits in this case, which are possibly of similar size or have a similar heating capacity.

In a development of the invention, at least one temperature sensor may be arranged on the heating device. To do so, a favorable arrangement is on or above the basic insulation layer in the region of a heating conductor circuit or of one of its heating conductors, preferably at a distance of less than 3 cm. By means of this temperature sensor, a characteristic case of an excess temperature at the heating device can then also be detected and, in addition to this, that possibly shortly after this the basic insulation layer will be penetrated or locally destroyed, with the previously described options for detecting this.

It is regarded as preferable for a cover to be provided on an exposed upper side of the heating conductor circuit or of its heating conductors, in particular as electrical insulation, for protection against destruction and for protection against fouling. This covering layer should cover all heating conductors of a heating conductor circuit and advantageously all heating conductor circuits of the heating device. This is preferably achieved with a single and common covering layer. This covering layer may be glass-like or have a proportion of glass, similarly to the basic insulation layer and/or the additional insulation layer, for its very good electrical insulation properties and temperature resistance.

These and further features are found in the description and in the drawings as well as in the claims, wherein the individual features can each be realized singly or severally in the form of sub-combinations in one embodiment of the invention and in other fields, and can represent embodiments advantageous and protectable per se, for which protection is claimed here. The subdivision of the application into individual sections and sub-headings does not limit the statements made thereunder in their general validity.

### BRIEF DESCRIPTION OF THE DRAWINGS

Exemplary embodiments of the invention are illustrated schematically in the drawings and explained in more detail below. The drawings show in:

FIG. 1 a rear view of a steam cooker as the electrical device in accordance with the invention, with a steam generator on the rear face, having a heating device in accordance with the invention,

FIG. 2 a simplified schematic sectional view through a heating device in accordance with the invention and

FIG. 3 a plan view onto a specific embodiment of a heating device in accordance with the invention.

### DETAILED DESCRIPTION OF THE EXAMPLES

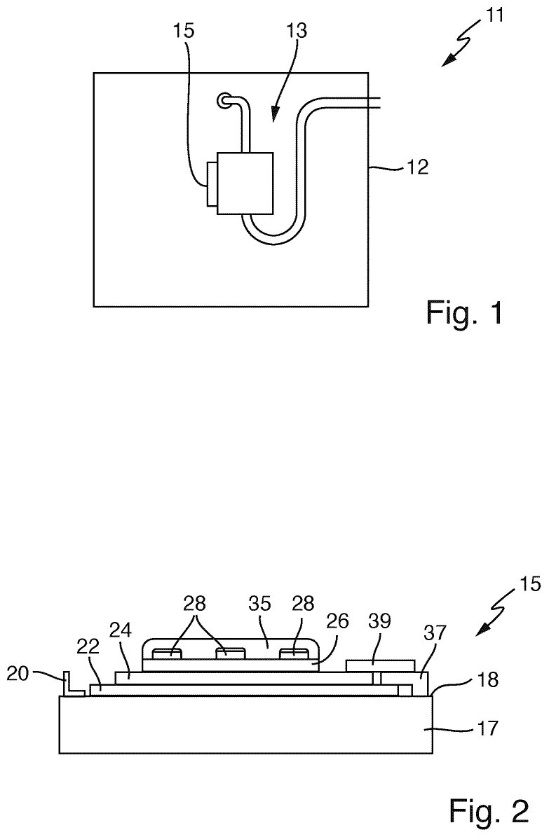

FIG. 1 shows a steam cooker 11 as the electrical device in accordance with the invention; it is even a water-carrying household appliance as stated at the outset. The steam cooker 11 has a housing 12, on the rear face of which a steam generator 13 is arranged in known manner. This steam generator 13 has a heating device 15 in accordance with the invention. This can be used to evaporate water inside a steam generating chamber or the like in known manner, and this steam is then passed into the interior of the steam cooker 11 for preparing food. A heating capacity for a steam generator 13 of this type or for a steam cooker 11 should be relatively high, to allow a sufficient amount of steam to be generated as quickly as possible. At the same time, a high degree of safety must be maintained, since the housing 12 of the steam cooker 11 can easily be touched by an operator and the steam generator 13 is of course arranged on its rear face.

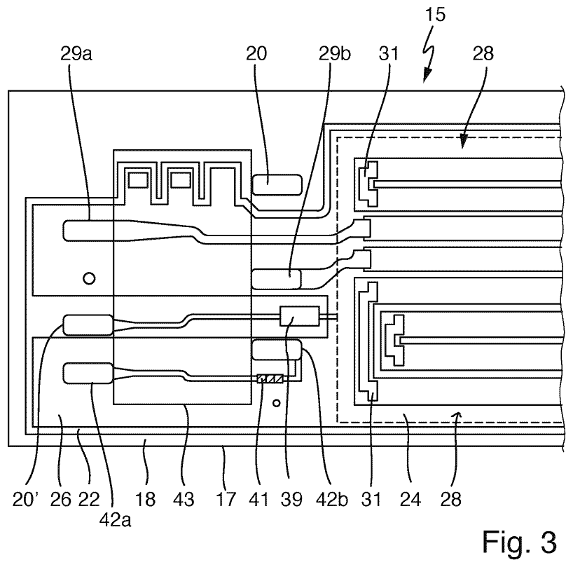

It can be seen from the schematic sectional view of FIG. 2 that a flat carrier 17 made of metal is provided. It may advantageously be designed flat or level, but this is not essential. A PE connection 20 corresponding to a ground connection as mentioned at the outset is provided on the far left of a carrier upper side 18. Advantageously, it is designed as a contact, for example as a projecting plug-in contact. As shown in FIG. 3, it may be attached, for example soldered or welded on, either directly to the carrier upper side 18, or alternatively it may also be attached to a contact field provided thereon. This PE connection is used in known manner also to ensure safety during operation of the heating device 15.

A substantial area of the surface of the carrier 17 or carrier upper side 18 is covered by an additional insulation layer 22. This may be glass-like or may contain glass in known manner. It can be applied to the carrier upper side 18 using a screen printing method with an appropriate paste and then stoved. It may be designed with one layer, alternatively also with several layers.

A conductive layer 24 of slightly smaller size may be applied to the additional insulation layer 22. It may be applied either as a closed surface, or alternatively in net or grid form, as is known per se from the prior art. The conductive layer 24 is electrically conductive or consists of electrically conductive material, and may therefore contain graphite and/or metal.

A so-called basic insulation layer 26 is applied in turn to the conductive layer 24, with a slightly smaller surface or smaller contour. It may consist of similar or identical material to the additional insulation layer 22. It may also be applied in the same way, possibly also as a single layer or in several layers.

Three heating conductors 28, shown schematically, are in turn applied on top of the basic insulation layer, which applies only for this example; they may be more or fewer in number. These are advantageously thick-film heating conductors which are applied using a screen printing method and then stoved. In this regard, reference is made to the prior art stated at the outset.

The heating conductors 28 are in turn covered by a covering layer 35 in the upward direction, such that they are completely sealed and protected from both mechanical damage from the outside and from contact with atmospheric oxygen. Also, they can in this way also be electrically insulated in the case of a suitable covering layer. The heating conductors 28 are electrically connected in a manner not shown.

A contact field 37 with a kind of step-like design that overlaps onto the additional insulation layer 22 is applied on the right of the carrier upper side 18. This overlap is provided so that an upper side of the contact field 37 is at about the same level as an upper side of the conductive layer 24. The contact field 37 could therefore also be provided next to the additional insulation layer 22, but at a corresponding height. This height of the contact field 37 has the advantage that a safety fuse in accordance with the invention may then be placed as an SMD component onto this contact field 37 at one end and may be fastened and also provided with electrical contact. The other, left-hand end rests on the conductive layer 24 or on an extension thereof. The safety fuse 39 is thus the only electrical connection from the conductive layer 24 to the outside, i.e. to the PE connection 20 via the contact field 37 and the electrically conductive carrier 17, which consists of metal.

It may be readily discerned from FIG. 2 that in the event of the heating conductors 28 being operated and hence passed through by current, developing too much heat, the basic insulation layer 26 may suffer damage. Damage to the basic insulation layer may occur due to local or partial limescale accumulation on the water side or underside of the carrier 17 or due to surface overheating, for example due to running dry. The heat generated by the heating conductors 28 is then insufficiently dissipated, and the problems mentioned at the beginning occur.

If this damage is such that the basic insulation layer 26 is burnt out or penetrated or loses its insulating properties, a current can flow from the heating conductors 28 through the basic insulation layer 26 or its damaged area to the conductive layer 24, and from the latter via the safety fuse 39 to the contact field 37, the carrier 17 and the PE connection 20. If this current is strong enough to exceed the previously mentioned 0.5 A or 0.1 A, the safety fuse 39 blows for example after 5 msec, if correspondingly rated. The fuse should therefore be rated such that the heating conductor is interrupted, making further operation impossible. The passage of the current via the conductive layer has the result that the additional insulation layer is not affected and the insulation stipulated in standards is still present after a failure. The fuse may be monitored, but this is not mandatory.

The electrical contact between the conductive layer 24 and the contact field 37 and hence the PE connection 20 is thus lost. This can be recognized as a fault and evaluated accordingly, for example because current flowed off for a very short time via the PE connection 20, or because an electrical connection between the conductive layer 24 on the one hand and the PE connection 20 on the other had been interrupted. The person skilled in the art knows enough possibilities for evaluation, requiring no detailed explanation here.

FIG. 3 shows in a plan view a detailed embodiment of a heating device 15 in accordance with the invention. A flat metal carrier 17 has the additional insulation layer 22 on its carrier upper side 18. A first PE connection 20 is provided on the carrier 17 or on its carrier upper side 18, and therefore goes directly to the carrier 17. A second PE connection 20′ is provided far left, which passes via a conductor track and a safety fuse 39 to a conductive layer 24 of net-like design shown as a dashed line. A net-like design of this type is generally known.

On the carrier upper side 18, the net-like conductive layer 24 is applied next to or on the specifically designed additional insulation layer 22, however only in the right-hand region and not in the left-hand one. It may be discerned on the right, next to the safety fuse 39, how a kind of conductor track is routed from the conductive layer 24 and to the safety fuse 39 as the contact for these.

A basic insulation layer, which leaves the second PE connection 20′ and the safety fuse 39 free, i.e. does not cover them, is in turn applied to the conductive layer 24. The elongated and straight-running heating conductors 28 are in turn provided on the basic insulation layer 26. They extend in parallel strips with bends of 180° or with short-circuit jumpers 31 at the ends. The heating conductors 28 form a single heating conductor circuit or have only two heating conductor contacts 29a and 29b. It would however also be possible to provide two or even more heating conductor circuits, which can be separately controlled and separately operated.

A covering layer, which may for example cover the extent of the conductive layer 24, is not shown but can be readily envisaged in FIG. 3.

In the event of a fault or damage to the basic insulation layer 26, current will flow from one of the heating conductors 28 through the basic insulation layer 26 and the conductive layer 24. This current will flow through the safety fuse 39 and cause the latter to melt or blow accordingly. The electrical connection to the PE connection 20′ is then removed or is no longer existent. This can be detected in the way previously described.

A plug frame 43, as is known for example from U.S. Pat. No. 9,196,990 B2, is shown by a dotted line. This may hold plug connection lugs which rest with laterally projecting feet on the PE connections 20 and 20′ and on the heating conductor contacts 29a and 29b, and are permanently soldered or welded there. This is used for rapid and simple electrical contacting by means of an appropriate plug.

A separate temperature capture is possible by a temperature sensor 41 which advantageously rests on the basic insulation layer 26, particularly advantageously as an SMD temperature sensor. It has two temperature sensor contact fields 42a and 42b, which can also be electrically contacted by means of the plug as mentioned.

It can easily be seen from the illustrations that in the event that several separate heating conductor circuits are provided, they should each have their own safety fuse. It can be achieved in this way that even when only a single heating conductor circuit fails or is permanently switched off, it is possible for heating operation to continue.

1. A heating device with:
a carrier,
an electrically insulating basic insulation layer on said carrier,
at least one heating conductor circuit on said electrically insulating basic insulation layer, wherein said at least one heating conductor circuit has at least one heating conductor,
electrical connections on said heating conductor circuit,
wherein
an electrically insulating additional insulation layer is arranged on said carrier underneath said electrically insulating basic insulation layer and between said electrically insulating basic insulation layer and said carrier,
an electrically conductive layer is arranged distributed over a surface of said electrically insulating additional insulation layer such that said electrically insulating basic insulation layer is arranged on said electrically conductive layer,
a ground connection is provided on said carrier or on said electrically insulating additional insulation layer, wherein said ground connection is electrically connected to ground,
a safety fuse is arranged between said electrically conductive layer and said carrier or between said electrically conductive layer and said ground connection as an only electrical connection between said electrically conductive layer and said carrier or between said electrically conductive layer and said ground connection.

2. The heating device according to claim 1, wherein said carrier is electrically conductive and said ground connection is arranged on said carrier and is connected thereto in electrically conducting manner, wherein said safety fuse reaches from said electrically conductive layer directly onto said carrier and is electrically connected to said carrier and hence to said ground connection.

3. The heating device according to claim 1, wherein an electrically conductive contact field is applied to said carrier next to said additional insulation layer, and said safety fuse reaches from said electrically conductive layer directly onto said contact field and is connected thereto in electrically conducting manner, wherein said carrier is electrically conductive and has said ground connection.

4. The heating device according to claim 3, wherein said contact field is at a level such that an upper side of said contact field is at the same level as an upper side of said electrically conductive layer.

5. The heating device according to claim 1, wherein an additional contact field is applied to said additional insulation layer and is connected in electrically conductive manner to a ground connection, wherein said safety fuse is connected to said additional contact field in electrically conductive manner.

6. The heating device according to claim 1, wherein said safety fuse is designed as a metal part.

7. The heating device according to claim 6, wherein said safety fuse is designed as an exposed or freely extending metal part.

8. The heating device according to claim 6, wherein said safety fuse is designed as an SMD component for fastening and for electrical contact by means of SMD soldering.

9. The heating device according to claim 1, wherein said safety fuse is designed as a fast-blow fuse.

10. The heating device according to claim 9, wherein said safety fuse is designed as a fast-blow fuse with a reaction time of less than 50 msec.

11. The heating device according to claim 1, wherein said safety fuse is designed such that it blows when a current strength of a maximum of 0.5 A is reached.

12. The heating device according to claim 10, wherein said safety fuse is designed such that it blows when a current strength of a maximum of 0.1 A is reached.

13. The heating device according to claim 1, wherein said safety fuse is designed such that after it has blown, said additional insulation layer electrically insulates said heating conductors against said carrier without damage.

14. The heating device according to claim 1, wherein said electrically conductive layer and said basic insulation layer extend over a surface within which said at least one heating conductor of said heating conductor circuit extends.

15. The heating device according to claim 14, wherein said basic insulation layer extends over a surface of said electrically conductive layer.

16. The heating device according to claim 1, wherein said electrically conductive layer is designed as a net or grid.

17. The heating device according to claim 1, wherein said electrically conductive layer is designed in strips with a width of max. 3 mm.

18. The heating device according to claim 17, wherein said strips extend in meandering form.

19. The heating device according to claim 1, having several said heating conductor circuits operable separately from one another and each said heating conductor circuit having at least one said heating conductor, wherein for each said heating conductor circuit one said separate electrically conductive layer is provided extending over a corresponding surface, and said heating conductor circuit extends over said surface.

20. The heating device according to claim 19, wherein said heating device is designed such that a common basic insulation layer is provided for all said electrically conductive layers underneath all said heating conductor circuits.

21. The heating device according to claim 20, wherein a separate safety fuse with an electrically conducting connection to a ground connection is provided for each said heating conductor circuit and for each said associated electrically conductive layer.

22. The heating device according to claim 1, wherein at least one temperature sensor is arranged on said heating device, wherein said at least one temperature sensor is arranged on or above said basic insulation layer in a region of one said heating conductor circuit or of one of said heating conductors.

23. The heating device according to claim 1, wherein all said heating conductor circuits of said heating device or its heating conductors are covered by a covering layer and electrically insulated from an outside.

24. The heating device according to claim 23, wherein said covering layer extends onto said basic insulation layer, but not onto said electrically conductive layer located underneath said basic insulation layer.

25. An electrical device with at least one said heating device according to claim 1, wherein said electrical device is a water-carrying household appliance, and said heating device heats flowing or stationary water inside a water tank, a water circuit or a pump.
